(19) United States
(12) Patent Application Publication
(10) Pub. No.: US 2015/0301394 A1
(43) Pub. Date: Oct. 22, 2015

(54) LIQUID CRYSTAL DISPLAY APPARATUS

(71) Applicant: SHARP KABUSHIKI KAISHA, Osaka-shi, Osaka (JP)

(72) Inventor: Yoshihisa NOGUCHI, Osaka-shi (JP)

(73) Assignee: SHARP KABUSHIKI KAISHA, Osaka-shi, Osaka (JP)

(21) Appl. No.: 14/648,167

(22) PCT Filed: Nov. 28, 2013
(86) PCT No.: PCT/JP2013/082018

§ 371 Date: May 28, 2015

(30) Foreign Application Priority Data
Nov. 29, 2012 (JP) 2012-261293
Mar. 27, 2013 (JP) 2013-067253

(51) Int. Cl. G02F 1/1333

(52) U.S. Cl. CPC G02F 1/133308

(57) ABSTRACT

The liquid crystal display apparatus includes a liquid crystal module that has: a liquid crystal panel, an optical sheet, a backlight, and a box-shaped housing which has an opening on its front side and houses at least the optical sheet and the backlight, which are sequentially laminated from a front side to a rear side; and a frame-shaped member that covers peripheral surface sides of the liquid crystal panel and the housing. The liquid crystal display apparatus further includes: a frame body that extends along a peripheral edge of the liquid crystal module, have a cross section orthogonal to an extending direction formed in a U-shape opened toward the liquid crystal module, and is partially in contact with the housing and the frame-shaped member to hold the liquid crystal module; and a leaf spring that is installed at a portion where a rear surface of the housing and the frame body face each other, and presses the housing and the frame body so as to be separated from each other in the thickness direction of the housing.

### CROSS-REFERENCE TO RELATED APPLICATION

This application is the national phase under 35 U.S.C. §371 of PCT International Application No. PCT/JP2013/082018 which has an International filing date of Nov. 28, 2013 and designated the United States of America, which claims priority under 35 U.S.C. 119(a) to Patent Application Nos. 2012-261293 and 2013-067253, filed in Japan on Nov. 29, 2012 and Mar. 27, 2013, all of which are hereby expressly incorporated by reference into the present application.

### BACKGROUND

1. Technical Field

The present invention relates to a liquid crystal display apparatus.

2. Description of Related Art

In a liquid crystal display apparatus, respective members such as a liquid crystal panel, an optical sheet, and the like, which are laminated in a front-back direction, are supported by a bezel located at a peripheral edge thereof. By eliminating the bezel from the liquid crystal display apparatus, narrowing of a frame in the liquid crystal display apparatus has been progressed.

However, on the other hand, the liquid crystal display apparatuses including the bezel still continue to be produced due to existing production facilities, costs and the like. In the liquid crystal display apparatus including the bezel, in order to achieve the narrowing of the frame, it is conceivable that the respective members are fixed by four bar-shaped frame members coming into close contact with the bezel. The bar-shaped frame members have a U-shaped cross section opened inward, and respective members are pinched by the bar-shaped frame members.

Meanwhile, in an image display apparatus, there is a technique in which a frame fixed at a peripheral surface of a light guide plate is pressed in an in-plane direction of the light guide plate by an elastic member provided between a housing and the frame, thereby absorbing a deformation of the light guide plate in the in-plane direction (see Japanese Patent Application Laid-Open No. 2012-146504).

### SUMMARY

In the liquid crystal display apparatus, the respective members such as the liquid crystal panel laminated in the front-back direction have variations in a thickness thereof caused by manufacturing parameters. Therefore, the laminated respective members have variations in an entire thickness thereof. In order to reduce the variations in the entire thickness of the respective members, when the respective members are fixed by a strong force in the front-back direction using the four bar-shaped frame members, distortions, wrinkles, or the like occur in the liquid crystal panel and the optical sheet, such that image quality may be deteriorated.

On the other hand, when the respective members are fixed by a weak force in the front-back direction using bar-shaped frame members having a wide interval between portions which pinch the respective members, rattling occurs in the respective members, whereby assembly failure occurs in the liquid crystal display apparatus. By copying the image display apparatus of Japanese Patent Application Laid-Open No. 2012-146504, even if the elastic member is installed between the bar-shaped frame member and the bezel, a force by the elastic member acts in the in-plane direction of the respective members, thus not to contribute to fix the respective members in a thickness direction.

The present invention has been made with the aim of solving the above problems. An object of the present invention is to provide a liquid crystal display apparatus capable of facilitating narrowing of the frame, and fixing respective members while permitting variations in the thickness of the respective members laminated in a front-back direction.

A liquid crystal display apparatus according to the present invention includes a liquid crystal module having: a liquid crystal panel, an optical sheet, a backlight, and a box-shaped housing which has an opening on its front side and houses at least the optical sheet and the backlight, which are sequentially laminated from a front side to a rear side; and a frame-shaped member which covers peripheral surface sides of the liquid crystal panel and the housing. The liquid crystal display apparatus further includes: a frame body that extends along a peripheral edge of the liquid crystal module, has a cross section orthogonal to an extending direction formed in a U-shape opened toward the liquid crystal module, and is partially in contact with the liquid crystal panel, the housing and the frame-shaped member to pinch the liquid crystal module; and an elastic member that is installed at a portion where a rear surface of the housing and the frame body face each other, and presses the housing and the frame body so as to be separated from each other in a thickness direction of the housing.

In the liquid crystal display apparatus according to the present invention, the liquid crystal module has the liquid crystal panel, the optical sheet, the backlight, and the box-shaped housing, which are sequentially laminated from the front side to the rear side. The front side of the housing is opened, and the housing houses at least the optical sheet and the backlight. In addition, the liquid crystal module has the frame-shaped member which covers the peripheral surface sides of the liquid crystal panel and the housing. The liquid crystal display apparatus includes the frame body which extends along the peripheral edge of the liquid crystal module, has a cross section orthogonal to an extending direction formed in a U-shape opened toward the liquid crystal module. The frame body is partially in contact with the liquid crystal panel, the housing and the frame-shaped member to hold the liquid crystal module. The elastic member is installed at a portion where the rear surface of the housing and the frame body face each other. The elastic member presses the housing and the frame body so as to be separated from each other in the thickness direction of the housing.

Thereby, even in the liquid crystal module having variations in the thickness in the front-back direction, the elastic member can absorb the variations in the thickness of the liquid crystal module. Since the liquid crystal module is fixed with a proper force applied thereto by a pressing force exerted from the elastic member to the housing and the frame body, distortions, wrinkles, or the like do not occur in the liquid crystal panel, the optical sheet, and the like, and the image quality of the liquid crystal display apparatus is not deteriorated. In the liquid crystal display apparatus, since the frame body is in contact with the frame-shaped member forming the peripheral edge of the liquid crystal module, it is possible to achieve narrowing of the frame.

The liquid crystal display apparatus according to the present invention is characterized in that the elastic member may be a leaf spring.

In the liquid crystal display apparatus according to the present invention, the elastic member, which is installed at the portion where the rear surface of the housing and the frame body face each other, is the leaf spring.

The leaf spring is easily molded and fixed to the frame body, thus productivity of the liquid crystal display apparatus can be improved. In addition, since the leaf spring is inexpensive, a reduction in cost can be realized.

The liquid crystal display apparatus according to the present invention is characterized in that the leaf spring may have a hole, and the housing may be provided with a projection to be fitted in the hole on a rear surface thereof facing the hole.

In the liquid crystal display apparatus according to the present invention, the leaf spring has the hole, and the housing is provided with the projection to be fitted in the hole on a rear surface thereof facing the hole.

Thereby, the projection of the housing can be fitted to the hole of the leaf spring by a sequential operation of the leaf spring which elastically deforms while sliding on the projection. When the projection of the housing is fitted in the hole of the leaf spring, the frame body is fixed to the liquid crystal module having the variations in the thickness thereof.

The liquid crystal display apparatus according to the present invention is characterized in that the frame body may have a notch opened inward at a portion facing the rear surface of the housing, and the leaf spring may be provided so as to close at least a part of the notch.

In the liquid crystal display apparatus according to the present invention, the frame body is provided with the notch opened inward at the portion thereof facing the rear surface of the housing. The leaf spring closes a part or all of the notch provided in the frame body.

The notch of the frame body provides a space for allowing the leaf spring to be displaced by an elastic deformation thereof. Therefore, since there is no need to additionally provide a space for displacement of the leaf spring in the liquid crystal display apparatus, the notch contributes to the narrowing of the frame.

The liquid crystal display apparatus according to the present invention is characterized in that the leaf spring may be provided with a projection piece in an edge part thereof on an inside from the hole, and the projection piece may extend obliquely rearward with respect to the rear surface of the housing.

In the liquid crystal display apparatus according to the present invention, the projection piece is provided in the edge part of the leaf spring inside from the hole. The projection piece extends obliquely rearward with respect to the rear surface of the housing.

When attaching the frame body to the liquid crystal module with the U-shaped side of the frame body facing the inside of the liquid crystal module, the projection piece can guide the leaf spring, so that the hole of the leaf spring smoothly moves to the projection of the housing.

The liquid crystal display apparatus according to the present invention is characterized in that the liquid crystal module and the frame body may have a rectangular shape in a front view, respectively, and the elastic member may be provided on at least one side of the frame body facing the rear surface of the housing.

In the liquid crystal display apparatus according to the present invention, the liquid crystal module and the frame body have a rectangular shape in a front view, respectively. The elastic member is provided on one, two, three or four sides of the frame body facing the rear surface of the housing.

For example, if the elastic members are provided on the four sides of the frame body, the liquid crystal module is fixed with a uniform force with respect to four directions. Therefore, distortions, wrinkles, or the like do not occur in the liquid crystal panel, the optical sheet, and the like, and the image quality of the liquid crystal display apparatus is not deteriorated.

The liquid crystal display apparatus according to the present invention is characterized in that a smaller second notch than the notch may be further provided at the edge part of the notch in the extending direction of the frame body, a second projection piece may extend from the edge part of the leaf spring facing the second notch to the inside of the second notch, and the second projection piece may have a tip part being bent to the rear side.

In the liquid crystal display apparatus according to the present invention, the smaller second notch than the notch is provided at the edge part of the notch in the extending direction of the frame body. The second projection piece extends from the edge part of the leaf spring facing the second notch to the inside of the second notch. The tip part of the second projection piece is bent to the rear side.

When the leaf spring is deformed by a torsional force, etc. applied thereto from an outside, the second projection piece is in contact with an inner wall of the second notch, to thus regulate the displacement of the leaf spring. Thereby, it is possible to prevent the leaf spring from being damaged or dropped out from the frame body.

The liquid crystal display apparatus according to the present invention is characterized in that the notch may be formed in a rectangular shape, the leaf spring may be formed in a rectangular shape, and an end part of the leaf spring on a side opposite to a position, in which the second projection piece is provided, may be fixed to the edge part of the notch on a side opposite to the second notch.

In the liquid crystal display apparatus according to the present invention, the notch and the leaf spring are formed in a rectangular shape, respectively. The end part of the leaf spring on the side opposite to the position, in which the second projection piece is provided, is fixed to the edge part of the notch on a side opposite to the second notch.

The notch and the leaf spring are formed in a rectangular shape being easy molding, respectively. The leaf spring is formed in a rectangular shape, thereby being easily bent in a longitudinal direction. Since the leaf spring is displaced in the front-back direction in the space including the notch, when fixing the end part of the leaf spring to the vicinity of the notch, the end part of the leaf spring can be easily fixed to the edge part of the notch on a side opposite to the second notch.

The liquid crystal display apparatus according to the present invention is characterized in that the hole and the projection piece may be provided at a portion of the leaf spring which closes the notch.

In the liquid crystal display apparatus according to the present invention, the hole and the projection piece of the leaf spring are provided at the portion thereof which closes the notch of the frame body.

The portion of the leaf spring which closes the notch of the frame body is a portion in which the leaf spring is elastically deformed in the front-back direction. By providing the projection piece at the leaf spring portion to be elastically deformed, when attaching the frame body to the liquid crystal module, the projection piece allows for the leaf spring to move to the inside of the liquid crystal module, without blocking by the projection of the housing. In addition, by providing the hole at the leaf spring portion to be elastically deformed, when the leaf spring is warped to the front side by a restoring force based on the elastic deformation, the hole of the leaf spring can be fitted to the projection of the housing. When the projection of the housing is fitted in the hole of the leaf spring, the frame body is fixed with respect to the liquid crystal module.

The liquid crystal display apparatus according, to the present invention is characterized in that the frame body may be divided into four linear frame members, and the linear frame members may be an extrusion-molded product, respectively.

In the liquid crystal display apparatus according to the present invention, the frame body can be divided into four linear frame members. The frame members are an extrusion-molded product, respectively.

Thereby, the frame body can be easily produced and handled.

The liquid crystal display apparatus according to the present invention is characterized in that the projection may be loosely fitted to the hole so that the frame member can move in the extending direction thereof.

In the liquid crystal display apparatus according to the present invention, the projection of the housing is loosely fitted to the hole of the leaf spring, so that the frame member can move in the extending direction thereof.

Thereby, the frame members are coupled to each other at the end parts thereof by moving the frame members in the extending direction thereof.

The liquid crystal display apparatus according to the present invention is characterized by comprising a connecting member which connects the end parts of the frame members with each other.

In the liquid crystal display apparatus according to the present invention, the end parts of the frame members are connected with each other by the connecting member.

Thereby, the frame members fixed to the liquid crystal module are coupled to each other, such that the strength of the liquid crystal display apparatus can be increased.

The liquid crystal display apparatus according to the present invention is characterized in that the leaf spring may have a screw insertion hole for fixing it to the frame body by a screw.

In the liquid crystal display apparatus according to the present invention, the leaf spring is fixed to the frame body by the screw. For this, the leaf spring is provided with the screw insertion hole.

Thereby, the leaf spring can be firmly fixed to the frame body.

The liquid crystal display apparatus according to the present invention is characterized in that the leaf spring may have: a contact part which extends in the extending direction of the frame body, and is in contact with the rear surface of the housing; a separation part which is separated from the rear surface of the housing; and a connection part which extends from an end part of the contact part in the extending direction of the frame body to the inside and the rear side thereof, and connects the contact part with the separation part. The liquid crystal display apparatus is characterized in that the hole may be provided in the contact part, and the screw insertion hole may be provided in the separation part.

In the liquid crystal display apparatus according to the present invention, the leaf spring has the contact part, the separation part and the connection part. The contact part is formed in a shape extending in the extending direction of the frame body, and is in contact with the rear surface of the housing. The separation part is separated from the rear surface of the housing. The connection part extends from the end part of the contact part in the extending direction of the frame body to the inside and the rear side thereof, and connects the contact part and the separation part with each other. The contact part is provided with the hole to which the projection of the housing is fitted. The separation part is provided with the screw insertion hole for fixing the leaf spring to the frame body by the screw.

Thereby, when attaching the frame body to the liquid crystal module, the connection part is bent, as a result, the contact part presses the housing and the frame body in a direction being separated from each other. Therefore, the leaf spring can fix the respective members of the liquid crystal display apparatus while permitting variations in the thickness of the liquid crystal module in the front-back direction.

The liquid crystal display apparatus according to the present invention is characterized in that the separation part may have a cross section orthogonal to the extending direction of the frame body formed in a U shape opened outward, and pinch a portion of the frame body facing the rear surface of the housing. The liquid crystal display apparatus is characterized in that the screw insertion hole may be provided at a portion of the separation part being in contact with an outer surface of the frame body, and the frame body may be provided with a screw hole corresponding to the screw insertion hole.

In the liquid crystal display apparatus according to the present invention, the separation part has a cross section orthogonal to the extending direction of the frame body formed in a U shape opened outward. The separation part pinches the inner surface and outer surface of the frame body facing the rear surface of the housing. The screw insertion hole is provided in the portion of the separation part being in contact with the outer surface of the frame body facing the rear surface of the housing. The screw hole is provided in the portion corresponding to the screw insertion hole, in the frame body.

Thereby, a screw fastening operation for fixing the leaf spring to the frame body can be performed from the outside of the frame body, thereby improving the assembly work efficiency.

The liquid crystal display apparatus according to the present invention is characterized in that the separation part may be provided with a through hole which is separated from the screw insertion hole in the extending direction of the frame body, at a portion thereof which is in contact with the outer surface of the frame body facing the rear surface of the housing. The liquid crystal display apparatus is characterized in that the separation part may be further provided with a third projection piece which extends from the outer edge part of a portion thereof provided with the through hole, and the third projection piece may extend obliquely rearward with respect to the portion of the separation part. The liquid crystal display apparatus is characterized in that the frame body facing the through hole is provided with a second projection to be fitted to the through hole.

In the liquid crystal display apparatus according to the present invention, the separation part is provided with a through hole at the portion thereof which is in contact with the outer surface of the frame body facing the rear surface of the housing. The through hole is separated from the screw insertion hole in the extending direction of the frame body. The separation part is provided with a third projection piece which extends from the outer edge part of the portion thereof provided with the through hole. The third projection piece extends obliquely rearward with respect to the portion of the separation part. The second projection to be fitted to the through hole is provided in the portion of the frame body facing the through hole.

Thereby, the leaf spring can be more rigidly fixed to the frame body also by fitting the second projection to the through hole, in addition to the fixation by the screws. In addition, in order to fix the leaf spring to the frame body by the screws, when the portion of the frame body facing the rear surface of the housing is pinched by the separation part, the second projection rides on the third projection piece, such that the second projection can be smoothly fitted to the through hole.

A television receiver according to the present invention is characterized by comprising the liquid crystal display apparatus according to the above, and a receiving unit which receives television broadcasts, wherein the liquid crystal panel is configured to display an image according to the television broadcasts received by the receiving unit.

The television receiver according to the present invention includes the liquid crystal display apparatus and the receiving unit. The liquid crystal panel of the liquid crystal display apparatus displays an image according to the television broadcasts received by the receiving unit.

Thereby, when assembling the television receiver, it is possible to employ the liquid crystal module having variations in the thickness in front-back direction. The elastic member can absorb the variations in the thickness of the liquid crystal module. Since the liquid crystal module is fixed with a proper force applied thereto by the pressing force exerted from the elastic member to the housing and the frame body, distortions, wrinkles, or the like do not occur in the liquid crystal panel, the optical sheet, and the like, and the image quality of the television receiver is not deteriorated. In the television receiver, the frame body is in contact with the frame-shaped member forming the peripheral edge of the liquid crystal module, and thereby narrowing of the frame can be achieved. Accordingly, the television receiver can achieve a stylish appearance as desired by a user, and can be provided with a larger screen without changing the size of the housing.

According to the liquid crystal display apparatus of the present invention, it is possible to facilitate the narrowing of the frame, and fix the respective members laminated in the front-back direction while permitting variations in the thickness of the respective members.

The above and further objects and features will more fully be apparent from the following detailed description with accompanying drawings.

### BRIEF DESCRIPTION OF THE SEVERAL VIEWS OF THE DRAWINGS

FIG. 1 is a perspective view of a television receiver seen from a front side thereof;

FIG. 2 is a rear view of the television receiver;

FIG. 3 is a partial cross-sectional view of an upper center of the television receiver;

FIG. 4 is a perspective view of an upper frame, side frames, a lower frame, and a liquid crystal module seen from a rear side thereof;

FIG. 5 is a partial enlarged view of FIG. 4;

FIG. 6A is a perspective view of a leaf spring;

FIG. 6B is a perspective view of the leaf spring;

FIG. 7 is a view describing a process of attaching the upper frame to the liquid crystal module;

FIG. 8 is a view describing a process of attaching the upper frame to the liquid crystal module;

FIG. 9 is a view describing a process of attaching the upper frame to the liquid crystal module;

FIG. 10 is a view describing a process of attaching the upper frame to the liquid crystal module;

FIG. 11 is a rear view of the liquid crystal module to which the upper frame, the side frames and the lower frame are attached;

FIG. 12 is a partial perspective view of the liquid crystal module to which the side frame and the lower frame are attached, seen from the rear side;

FIG. 13 is a partial enlarged view of a left upper portion of the liquid crystal module and a part of each of the upper frame and the side frame, seen from the rear side;

FIG. 14 is a perspective view of the leaf spring;

FIG. 15A is a perspective view of the upper frame;

FIG. 15B is a perspective view of the upper frame; and

FIG. 16 is a cross-sectional view of the upper frame and the liquid crystal module attached to each other, cut on a horizontal plane passing through a projection 511.

### DETAILED DESCRIPTION

A liquid crystal display apparatus of one embodiment according to the present application includes a television receiver, an electronic blackboard, a monitor used by connecting to a tuner, a monitor used by connecting to a desktop type computer, and a display used in a digital signage. In addition, the liquid crystal display apparatus of one embodiment according to the present application includes a display used in a tablet type computer, a personal digital assistant (PDA) and a mobile phone. Hereinafter, as one example of the liquid crystal display apparatus, the television receiver will be described with reference to the drawings according to the embodiments thereof.

### Embodiment 1

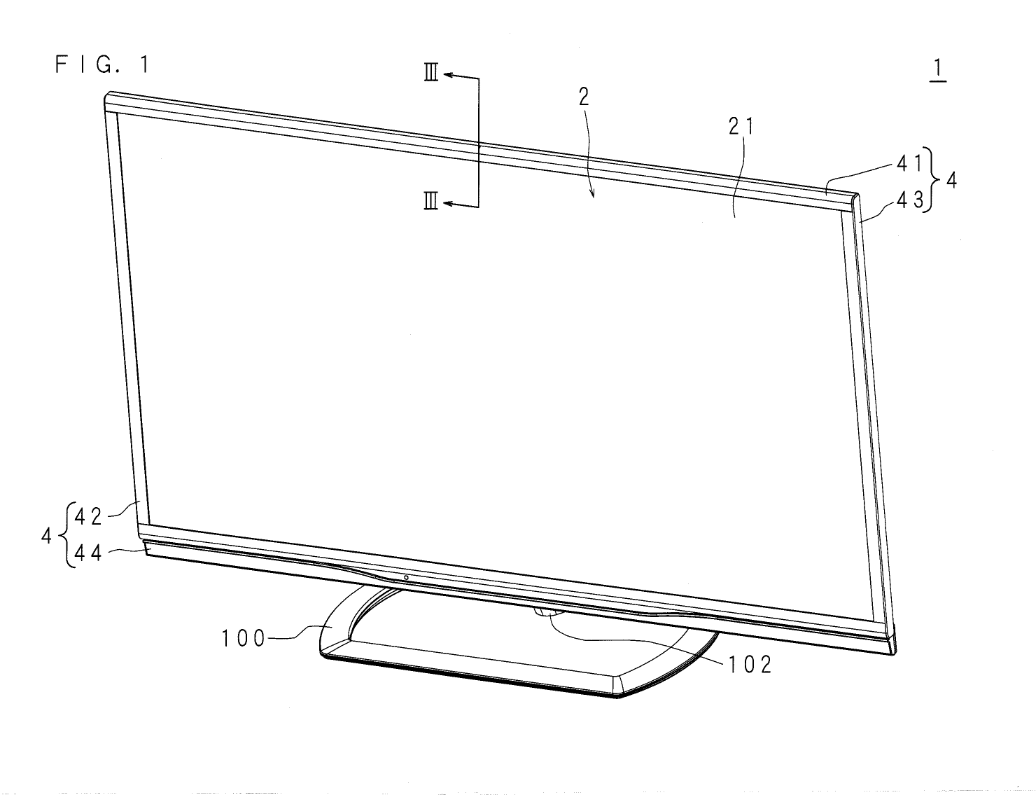

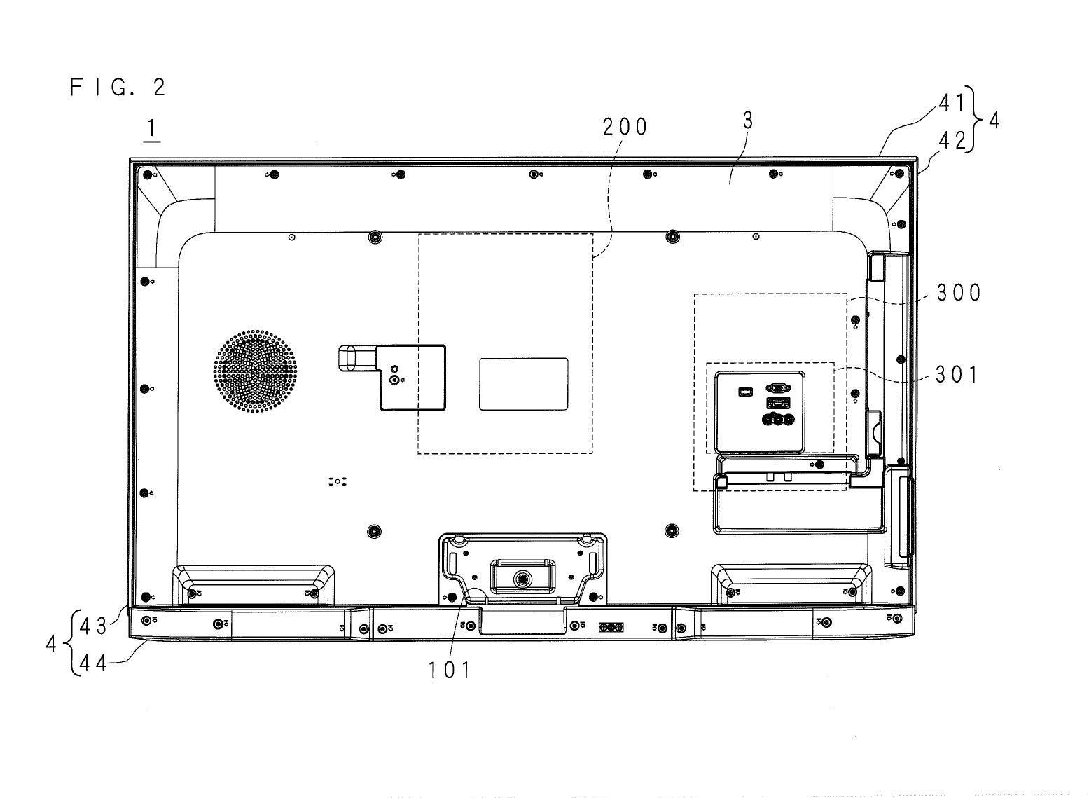

FIG. 1 is a perspective view of a television receiver 1 seen from a front side thereof. FIG. 2 is a rear view of the television receiver 1. Herein, when a viewer faces a screen 21 of the television receiver 1 in an upright state that displays an image, the viewer side of the screen 21 will be referred to as a front side, and the opposite side thereof will be referred to as a rear side or a back side. The screen 21 has a laterally long rectangular shape. When a viewer sees the screen 21, the right side of the screen 21 in a long side direction (a lateral direction) thereof will be referred to as right of the television receiver 1, and the left side of the screen 21 in the long side direction thereof will be referred to as left of the television receiver 1. Further, the upper side of the screen 21 in a short side direction (a vertical direction) thereof will be referred to as top of the television receiver 1, and the lower side of the screen 21 in the short side direction thereof will be referred to as bottom of the television receiver 1.

The television receiver 1 includes a liquid crystal panel 2, a back cabinet 3, a frame body 4 and a stand 100. The stand 100 is not illustrated in FIG. 2.

The liquid crystal panel 2 has the screen 21 on the front side, and displays an image on the screen 21. The back cabinet 3 is a part of a housing which covers the rear side of the television receiver 1. The back cabinet 3 may be made of a synthetic resin, for example, and is formed in a dish shape substantially protruding to the rear side.

The frame body 4 includes an upper frame (frame member) 41, two side frames (frame members) 42 and 43, and a lower frame (frame member) 44. In the assembled television receiver 1, the upper frame 41, two side frames 42 and 43, and the lower frame 44 form a united frame body 4. The frame body 4 is a part of a housing forming a front peripheral edge part and a peripheral surface of the television receiver 1. The frame body 4 is formed in a rectangular shape in a front view.

A part of the frame body 4 forms a rear peripheral edge part of the television receiver 1. However, the rear side portions of the upper frame 41, the side frames 42 and 43, and the lower frame 44 are covered with the back cabinet 3 with the exception of an outermost edge part thereof (see FIG. 2).

The stand 100 is a rectangular flat plate for supporting the television receiver 1 in the upright state with respect to the floor. An attaching part 101 of the stand 100 is provided at a center of the rear lower part of the television receiver 1. The stand 100 is fixed to the television receiver 1 through a post 102 fixed to the attaching part 101 using screws, for example.

The television receiver 1 includes a power supply board 200 and a main board 300. The power supply board 200 and the main board 300 are mounted inside of the back cabinet 3.

The power supply board 200 is a board on which a power supply device for supplying power to the respective components of the television receiver 1 are mounted. The main board 300 is a board on which a tuner (receiving unit) 301 which receives an image signal according to television broadcasts, an element for driving liquid crystals, a controller for controlling the respective components of the television receiver 1, and the like are mounted.

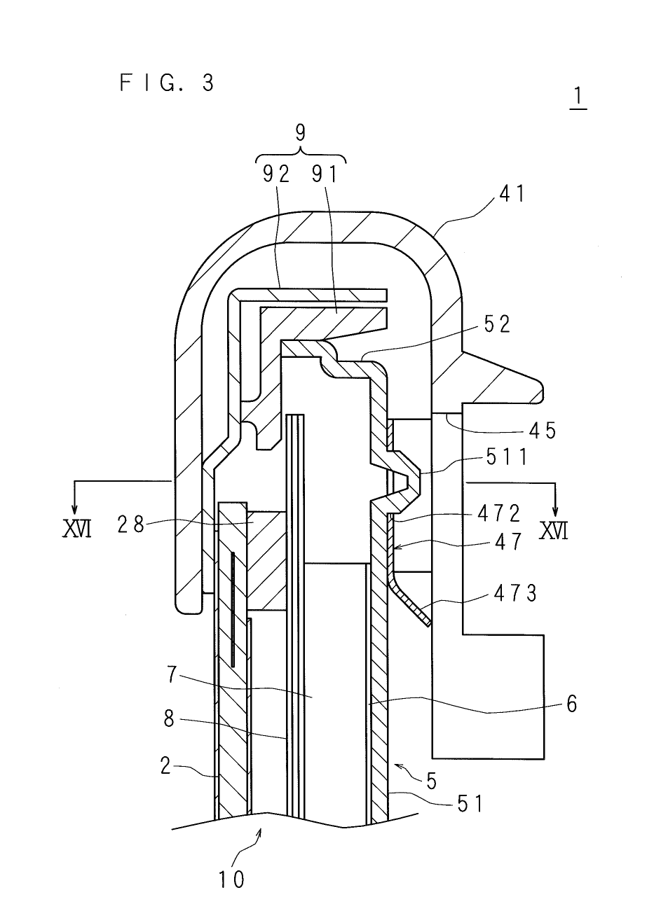

FIG. 3 is a partial cross-sectional view of an upper center of the television receiver 1. FIG. 3 illustrates a cross section taken on line in FIG. 1. The top, bottom, left and right in FIG. 3 correspond to the top, bottom, front side and rear side of the television receiver 1, respectively. The back cabinet 3 is not illustrated in FIG. 3.

The television receiver 1 includes a liquid crystal module 10. The liquid crystal module 10 is a major composite member of the television receiver 1, and is a member formed by assembling the liquid crystal panel 2, the backlight, a driving circuit and the like.

The liquid crystal module 10 includes a backlight chassis (housing) 5, a reflection sheet 6, a light guide plate 7, an optical sheet 8, a spacer 28, the liquid crystal panel 2 and a bezel (frame-shaped member) 9. In the liquid crystal module 10, the backlight chassis 5, the reflection sheet 6, the light guide plate 7, the optical sheet 8, the spacer 28 and the liquid crystal panel 2 are laminated from the rear side to the front side in this order.

The backlight chassis 5, the reflection sheet 6, the light guide plate 7, the optical sheet 8, the spacer 28 and the liquid crystal panel 2 included in the liquid crystal module 10 have variations in the respective thicknesses thereof in the front-back direction (the front-rear direction) caused by a manufacturing parameters of the respective members. Therefore, the liquid crystal module 10 has different thicknesses according to the portion thereof. The variations in the thickness of the liquid crystal module 10 is about 1.0 to 2.0 mm, for example.

The backlight chassis 5 may be made of iron, aluminum or copper, for example, and is a box-shaped board formed by pressing.

The backlight chassis 5 includes a bottom wall 51 and a side wall 52. The bottom wall 51 is a rectangular flat plate. The side wall 52 is bent from a peripheral part forming four sides of the bottom wall 51 to the front side. Accordingly, the backlight chassis 5 is formed in a box shape or a dish shape opened forward. The side wall 52 is provided at a part of the peripheral part of the bottom wall 51, and not provided at an entire periphery of the bottom wall 51.

When assembling the liquid crystal module 10, the reflection sheet 6, the light guide plate 7, the optical sheet 8, the spacer 28 and the liquid crystal panel 2 are laminated in this order on an inner bottom surface of the backlight chassis 5. The side wall 52 has a height substantially the same as a sum of the thicknesses of the reflection sheet 6, the light guide plate 7 and the optical sheet 8. The spacer 28 and the liquid crystal panel 2 are located at the front side from an opening surface of the backlight chassis 5, without being housed in the backlight chassis 5.

The bottom wall 51 is provided with a plurality of projections 511 formed on the peripheral edge part of the rear surface thereof. The projection 511 is formed in a circular column shape, and has a height of 1.5 mm, for example, and a diameter of 2 to 3 mm, for example. The projection 511 has a tip part formed in a truncated cone. The tip part of the projection 511 may be formed in a hemispherical shape.

The reflection sheet 6 is a film formed in a substantially rectangular shape corresponding to the bottom wall 51 of the backlight chassis 5. The reflection sheet 6 may be made of a synthetic resin having a high reflectivity, for example. In order to effectively use light emitted from the light guide plate 7 to the rear side, the reflection sheet 6 reflects the light to the front side.

The light guide plate 7 is a flat plate having rectangular front and rear surfaces, and may be made of an acrylic resin, for example. The light guide plate 7 diffuses the incident light from light emitting diodes (LEDs, not illustrated) disposed to face the lower side surface thereof, and emits the diffused light from the front surface to the optical sheet 8 and the liquid crystal panel 2.

The reflection sheet 6, the light guide plate 7 and the light emitting diodes are parts included in the backlight of the television receiver 1.

The optical sheet 8 is a substantially rectangular film. The optical sheet 8 has a size substantially the same as that of the light guide plate 7 and the liquid crystal panel 2.

The optical sheet 8 includes, for example, one reflective polarizing sheet, one diffusion sheet and two prism sheets. The reflective polarizing sheet, for example, has a multi-layer structure in which layers having different refractive indices from each other are alternately laminated, and separates the light with enhanced directivity into p-wave and s-wave, then selectively allows only the p-waves to transmit there through and selectively reflects the s-waves. The diffusion sheet diffuses the light. The prism sheet includes a plurality of lenses arranged adjacent to each other, and controls a traveling direction of the light.

The optical sheet 8 may include a viewing angle expansion sheet for expanding the range of a visual angle so as to obtain excellent display performance.

The spacer 28 is a frame-shaped member for controlling a gap between the peripheral edge part of the optical sheet 8 and the peripheral edge part of the liquid crystal panel 2. The spacer 28 may be omitted.

The bezel 9 includes four long members disposed at upper, lower, left and right sides of the liquid crystal module 10. The bezel 9 has a function for increasing the strength of the liquid crystal module 10 by covering the upper, lower, left and right sides of the liquid crystal module 10. The respective long members are not jointed to each other, but in the liquid crystal module 10 after assembling, the respective long members are formed in a substantially rectangular frame shape as a whole.

The bezel 9 includes an inner bezel 91 and an outer bezel 92. The inner bezel 91 may be made of a synthetic resin, for example. The inner bezel 91 has an L-shaped cross section orthogonal to the extending direction, and a corner thereof is located at a front peripheral edge part of the liquid crystal module 10. The inner bezel 91 covers the side wall 52 of the backlight chassis 5, the side surface sides of the reflection sheet 6, the light guide plate 7 and the optical sheet 8, and the peripheral edge of the opening surface of the backlight chassis 5.

The outer bezel 92 may be made of metal, for example. The outer bezel 92 has an L-shaped cross section orthogonal to the extending direction, and has a larger size than the inner bezel 91. A corner of the outer bezel 92 is located at the front side and outside from the corner of the inner bezel 91. The outer bezel 92 covers the inner bezel 91 from the outside, and also covers the front peripheral edge part of the liquid crystal panel 2.

When cutting on a cutting plane orthogonal to the extending direction, the upper frame 41 has a cross section formed in a U shape opened toward an upper side surface of the liquid crystal module 10. The front and rear corners of the upper frame 41 are formed to be roundish, respectively. A front inner surface of the upper frame 41 is in contact with the front side of the outer bezel 92. A rear inner surface of the upper frame 41 is slightly separated from the bottom wall 51 of the backlight chassis 5. However, the upper frame 41 is provided with a leaf spring 47 to be described below, and the leaf spring 47 is in contact with the bottom wall 51. A surface of the leaf spring 47 is substantially parallel to the rear surface of the upper frame 41 and the bottom wall 51 of the backlight chassis 5. The leaf spring 47 is provided with a long hole 472 to be described below, and the projection 511 is fitted to the long hole 472. Thereby, the upper frame 41 is fixed to the liquid crystal module 10. An upper part of the liquid crystal module 10 is held by the front portion of the upper frame 41 and the leaf spring 47 provided at the rear portion of the upper frame 41.

When cutting on a cutting plane orthogonal to the extending direction, the side frames 42 and 43, and the lower frame 44 also have cross sections formed in a U shape opened toward the side surface of the liquid crystal module 10 similar to the upper frame 41.

The side frames 42 and 43 are also provided with the leaf springs 47 at the rear portions thereof. The side frames 42 and 43 are also fixed to the liquid crystal module 10 by fitting the projections 511 of the bottom wall 51 to the long holes 472. The side parts of the liquid crystal module 10 are held by the front portions of the side frames 42 and 43 and the leaf springs 47 provided at the rear portions of the side frames 42 and 43.

The lower frame 44 is not provided with the leaf spring 47. The lower part of the liquid crystal module 10 is held by the front portion and the rear portion of the lower frame 44.

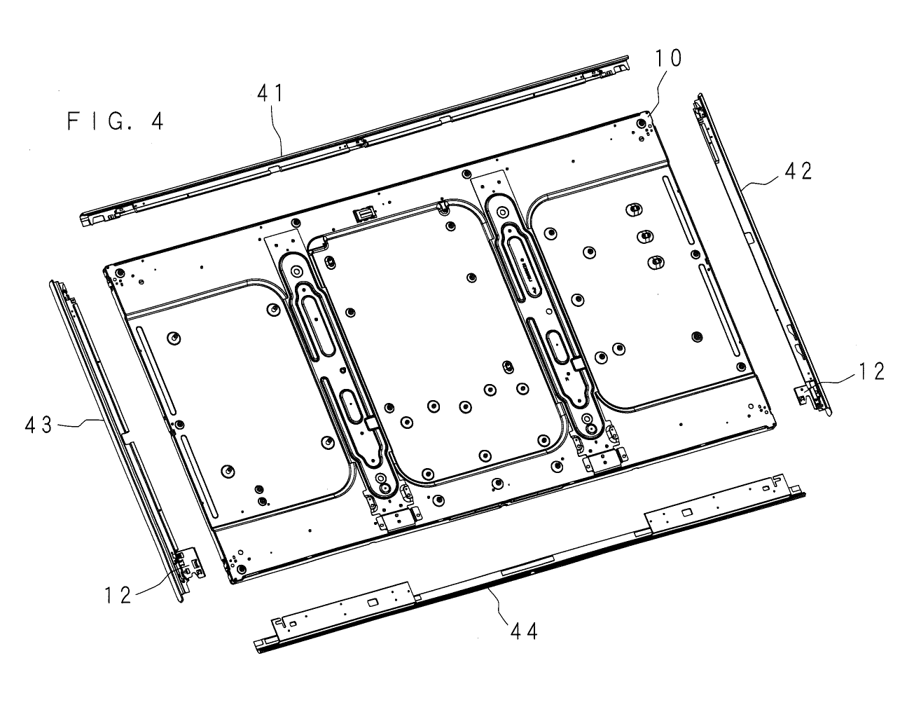

FIG. 4 is a perspective view of the upper frame 41, the side frames 42 and 43, the lower frame 44, and the liquid crystal module 10, seen from the rear side thereof.

When attaching the upper frame 41, the side frames 42 and 43, and the lower frame 44 to the liquid crystal module 10, each frame is made to approach the side surface of the liquid crystal module 10 from the side opened in a U shape. Then, the respective upper and side edge parts of the liquid crystal module 10 are sandwiched by the front inner surfaces of the upper frame 41 and the side frames 42 and 43, and the leaf springs 47. In addition, the lower edge part of the liquid crystal module 10 is sandwiched by the front inner surface and the rear inner surface of the lower frame 44. In this case, since the liquid crystal module 10 has variations in the thickness thereof, the upper frame 41, the side frames 42 and 43, and lower frame 44 excluding the leaf spring 47 are in contact with a thickest portion of the bottom wall 51 of the liquid crystal module 10, but are not in contact with a portion other than the thickest portion of the bottom wall 51. Herein, the thickness of the liquid crystal module 10 is the thickness of the peripheral edge part thereof to which the frame body 4 is attached.

As shown in FIG. 3, a small gap is generated between the upper frame 41 attached to the liquid crystal module 10 and the side surface of the outer bezel 92. On the other hand, although not shown in FIG. 3, the side frames 42 and 43, and the lower frame 44, which are attached to the liquid crystal module 10 are configured to be in contact with the side surface of the outer bezel 92. However, a gap of about 0.5 to 1 mm may be formed between the side frames 42 and 43 attached to the liquid crystal module 10 and the side surface of the outer bezel 92, and may be formed between the lower frame 44 attached to the liquid crystal module 10 and the side surface of the outer bezel 92, as an allowance.

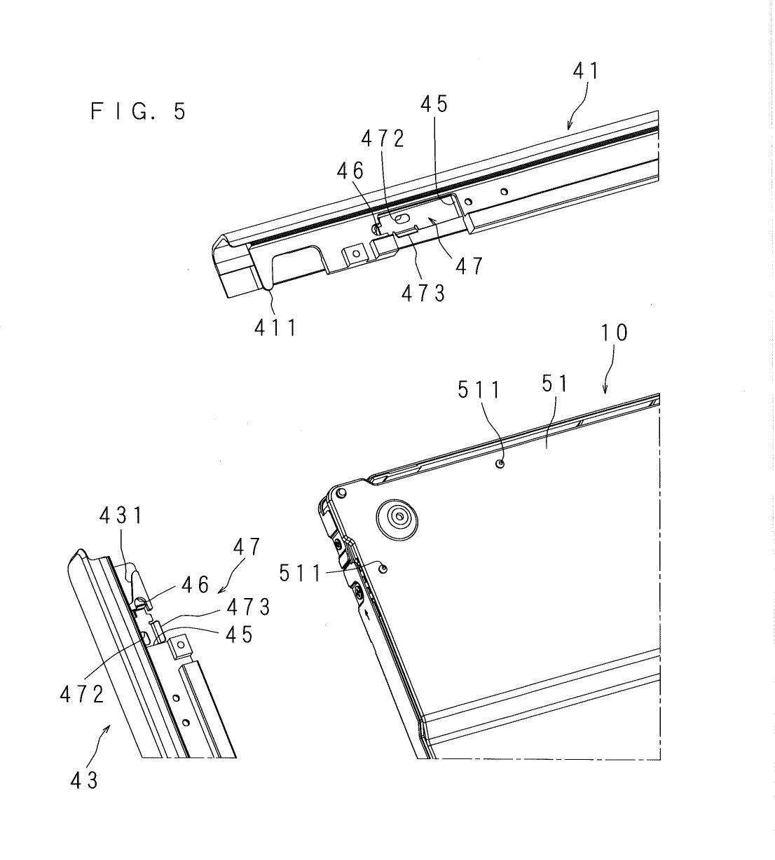

FIG. 5 is a partial enlarged view of FIG. 4. FIG. 5 illustrates the left upper portion of the liquid crystal panel 2, and a part of each of the upper frame 41 and the side frame 43, seen from the rear side thereof.

The upper frame 41 and the side frame 43 respectively include a first notch (notch) 45, a second notch 46 and the leaf spring 47. Although not shown in FIG. 5, the side frame 42 also includes the first notch 45, the second notch 46 and the leaf spring 47. On the other hand, the lower frame 44 is not provided with the first notch 45, the second notch 46 and the leaf spring 47.

When attaching the frame body 4 to the liquid crystal module 10, the first notch 45, the second notch 46 and the leaf spring 47 are disposed at positions substantially coinciding with the plurality of projections 511 provided on the rear surface of the bottom wall 51. In the case of the upper frame 41, the first notch 45, the second notch 46 and the leaf spring 47 are respectively disposed at three positions of both end parts and a center of the upper frame 41, for example. In the case of the side frames 42 and 43, the first notch 45, the second notch 46 and the leaf spring 47 are disposed at two positions of both end parts of respective side frames 42 and 43, for example.

The first notch 45 is provided in the rear portion of each of the upper frame 41 and the side frames 42 and 43, which are respectively facing the rear surface of the bottom wall 51. The first notch 45 is formed in a rectangular shape opened inward, and formed in a shape extending in the extending direction of each of the upper frame 41 and the side frames 42 and 43.

The second notch 46 is smaller than the first notch 45, and is formed in any one side of two opposite sides of the first notch 45 in the respective extending directions of the upper frame 41 and the side frames 42 and 43. The second notch 46 is formed along the extending direction of each of the upper frame 41 and the side frames 42 and 43, and has a tip part formed in a convex semicircular shape in a cut direction.

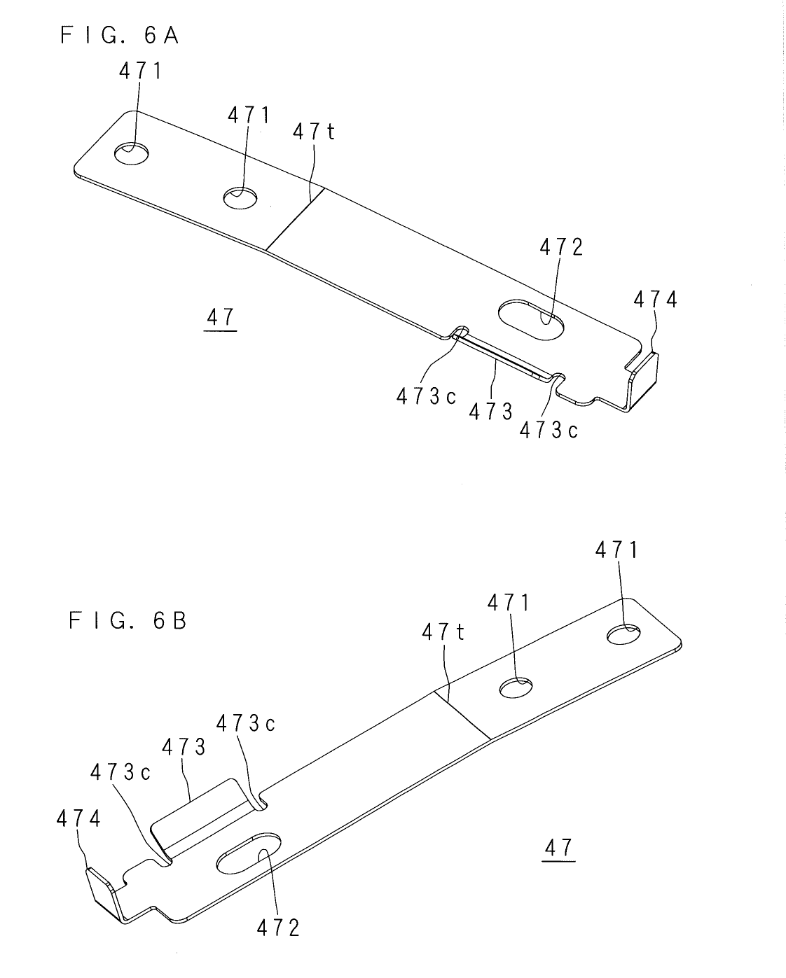

FIGS. 6A and 6B are perspective views of the leaf spring 47. FIG. 6A illustrates the rear side of the leaf spring 47 seen from the inside to the outside of the television receiver 1. FIG. 6B illustrates the rear side of the leaf spring 47 seen from the outside to the inside of the television receiver 1.

The leaf spring 47 is a rectangular flat plate extending in an elongated manner. The leaf spring 47 has a longer longitudinal length than the longitudinal length of the first notch 45 provided in each of the upper frame 41 and the side frames 42 and 43. The leaf spring 47 may be made of a material such as stainless steel or iron steel, for example.

The leaf spring 47 includes two circular holes 471, one long hole (hole portion) 472, a first projection piece (projection piece) 473 and a second projection piece 474. The leaf spring 47 can be divided into a region in which the two circular holes 471 are provided (hereinafter, referred to as a joint region), and a region in which the one long hole 472 is provided (hereinafter, referred to as a non-joint region), in the longitudinal direction. A ratio of the lengths of the joint region and the non joint region is 1:2, for example. The non-joint region has a narrower area than the areas of the first notch 45 and the second notch 46, which are provided in each of the upper frame 41 and the side frames 42 and 43.

The leaf spring 47 is bent forward at a slight angle (for example, 2 to 3 degrees) by a bending line 47t in a shorter direction between the joint region and the non joint region. In addition to being discontinuously bent at the bending line 47t, the leaf spring 47 may be continuously curved.

The circular hole 471 is a circular through hole. The two circular holes 471 are provided in series in the leaf spring 47 along the longitudinal direction thereof.

The long hole 472 is a long circular through hole extending in the longitudinal direction of the leaf spring 47. The long hole 472 has a longer major axis than the diameter of the circular column-shaped projection 511 provided on the backlight chassis 5. The long hole 472 has a minor axis with a length substantially the same as the diameter of the projection 511. The shape of the long hole 472 is not limited to the long circular shape. The overall shape of the long hole 472 may be a circular, elliptical, oval, rectangular shape or the like.

The first projection piece 473 is a rectangular projection extending in the shorter direction of the leaf spring 47 from the long side edge part of the non-joint region. A direction connecting the center of the first projection piece 473 and the center of the long hole 472 is substantially the same as the shorter direction of the leaf spring 47. Substantially U-shaped notches 473c are provided at two positions of the long side edge part of the leaf spring 47 adjacent to a base of the first projection piece 473. The first projection piece 473 extends obliquely rearward with respect to the flat surface of the leaf spring 47.

The second projection piece 474 is a rectangular protrusion extending in the longitudinal direction of the leaf spring 47 from the short side edge part of the non joint region. The second projection piece 474 has a tip part bent at substantially a right angle to the rear side of the television receiver 1.

The joint region of the leaf spring 47 is jointed to respective flat inner surfaces of the upper frame 41 and the side frames 42 and 43, so that the non-joint region closes a part of the respective first notches 45 of the upper frame 41 and the side frames 42 and 43 (see FIG. 5). A method of jointing the joint region of the leaf spring 47 to the respective inner surfaces of the upper frame 41 and the side frames 42 and 43 may employ caulking using a rivet, or the like, for example. When jointing the leaf spring 47 to each of the upper frame 41 and the side frames 42 and 43, the position of the leaf spring 47 is controlled so that the first projection piece 473 is located inside of the first notch 45, and the second projection piece 474 is present in the second notch 46.

The non-joint region is bent to the front side at the bending line 47t. Therefore, when the joint region of the leaf spring 47 is jointed to each of the upper frame 41 and the side frames 42 and 43, the non-joint region becomes to be in a state protruding to the front side from the first notch 45 of each of the upper frame 41 and the like. A degree of the non-joint region protruding to the front side from the first notch 45 is controlled, so that the leaf spring 47 can press the bottom wall 51 of the backlight chassis 5 to the front side by the elastic force when the upper frame 41, etc. are attached to the liquid crystal module 10.

The positions of the first notch 45 and the second notch 46 of the upper frame 41, etc. and the position of the long hole 472 of the leaf spring 47 are defined, so that a central position of the long hole 472 substantially coincides with a central axis of the projection 511 when the upper frame 41, etc. are attached to the liquid crystal module 10.

The non-joint region of the leaf spring 47 may have an area substantially the same as or wider than that of the first notch 45. In this case, the non-joint region closes the whole of the first notch 45.

In addition, the joint region of the leaf spring 47 may be jointed to the respective outer surfaces of the upper frame 41 and the side frames 42 and 43.

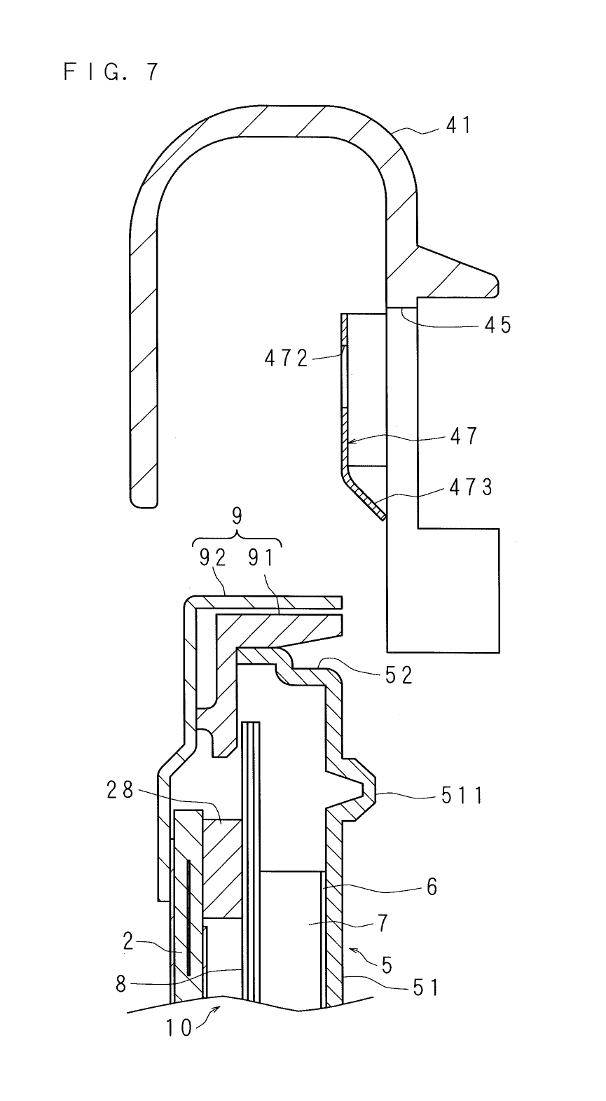

FIGS. 7, 8, 9 and 10 are views describing a process of attaching the upper frame 41 to the liquid crystal module 10. FIGS. 7, 8, 9 and 10 illustrate the process of attaching the upper frame 41 to the liquid crystal module 10 on the cross section taken on line in FIG. 1. The top, bottom, left and right in FIGS. 7, 8, 9 and 10 correspond to the top, bottom, front side and rear side of the television receiver 1, respectively.

The position of the upper frame 41 is defined so that the side of the upper frame 41 opened in a U shape faces the upper side surface of the liquid crystal module 10 (see FIG. 7). In addition, the upper frame 41 is close to the upper part of the liquid crystal module 10, in a state that the extending direction thereof is substantially parallel to the upper side surface of the liquid crystal module 10 (see FIGS. 4, 5 and 7). At this time, the surface of the leaf spring 47 is substantially parallel to the bottom wall 51 of the backlight chassis 5. Then, positioning of the upper frame 41 with respect to the liquid crystal module 10 is performed, so that the long hole 472 of the leaf spring 47 faces the projection 511 of the backlight chassis 5.

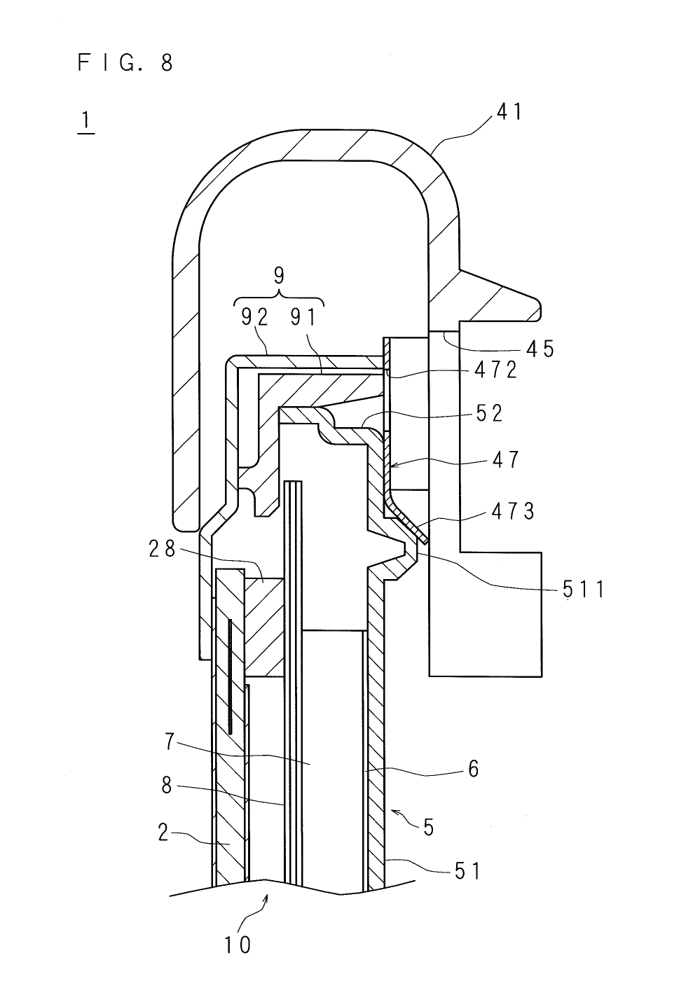

In a state of pinching the upper end part of the liquid crystal module 10 by the upper frame 41, or in a state that the upper frame 41 faces the upper part of the liquid crystal module 10, the upper frame 41 translates to the center side of the liquid crystal module 10 (see FIG. 8). The front inner surface of the upper frame 41 slides on the front surface of the outer bezel 92. The rear inner surface of the upper frame 41 moves to the center side of the liquid crystal module 10, with being separated from the bottom wall 51 of the backlight chassis 5. However, since the non-joint region of the leaf spring 47 is bent to the front side, the non joint region slides on the bottom wall 51 while pressing the bottom wall 51 to the front side. Finally, the first projection piece 473 of the leaf spring 47 reaches in the front of the projection 511 of the backlight chassis 5 (see FIG. 8).

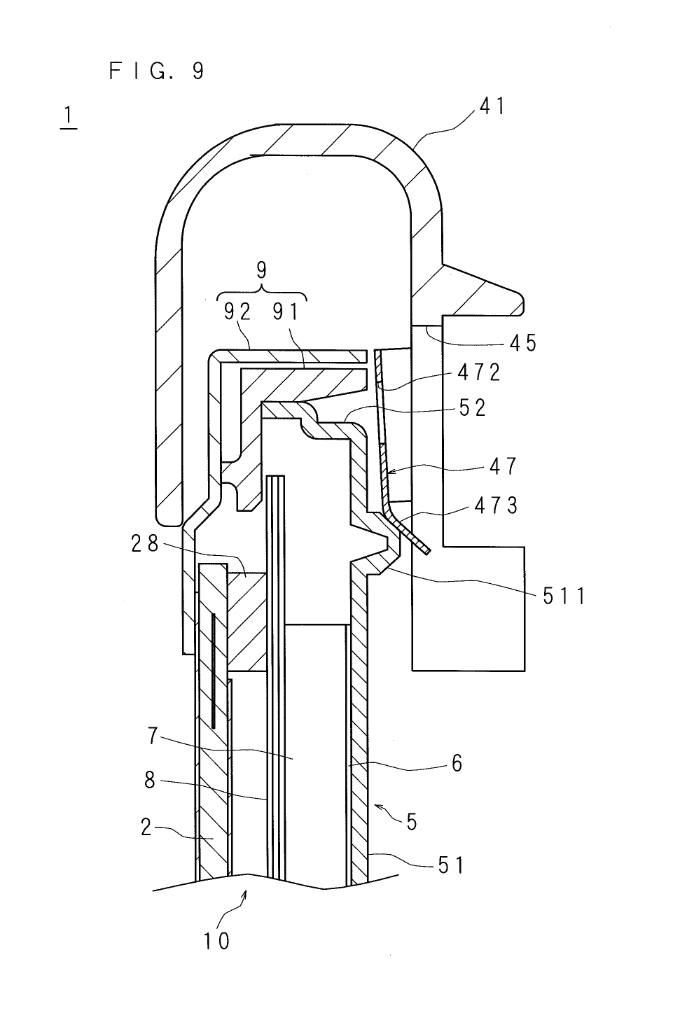

Further, when the upper frame 41 continuously moves to the center side of the liquid crystal module 10, the first projection piece 473 of the leaf spring 47 bent obliquely rearward rides on a taper portion of the tip part in the projection 511, and is elastically deformed to the rear side, thereby exceeding the position of the opening surface in the first notch 45 (see FIG. 9). The flat portion of the leaf spring 47 in the inside from the long hole 472 is guided by the first projection piece 473 to be elastically deformed to the rear side, thereby smoothly climbing over the projection 511 to move to the center side from the liquid crystal module 10. Then, the long hole 472 is close to the projection 511.

Since the liquid crystal module 10 has variations in the thickness thereof, the projection 511 also has a small variation in the height thereof with respect to the leaf spring 47. However, when climbing over the projection 511, the leaf spring 47 is elastically deformed according to the height of the projection 511. Therefore, the upper frame 41 can be flexibly attached to the liquid crystal module 10 having the variations in the thickness thereof.

The first notch 45 is provided for creating a space allowing the leaf spring 47 to be elastically deformed. If the first notch 45 is not provided, the leaf spring 47 ridden on the projection 511 is deformed to the rear side, and collides with the rear surface of the upper frame 41. Therefore, further movement of the leaf spring 47 to the rear side is limited.

If the space for allowing the leaf spring 47 to be elastically deformed can be previously prepared between the inner surface of the frame body 4 and the rear surface of the liquid crystal module 10, the first notch 45 may be omitted. However, in this case, the thickness of the television receiver 1 in the front-back direction thereof is increased by as much as the size of the previously prepared space, thereby causing greater difficulty in thinning thereof.

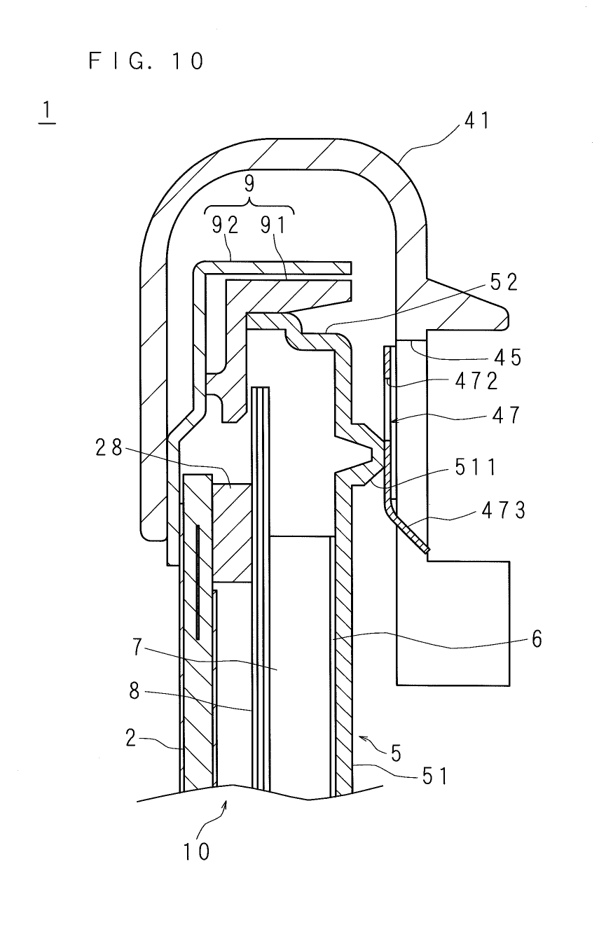

The flat portion of the leaf spring 47 in the inside from the long hole 472 rides on the tip part of the projection 511 (see FIG. 10). The upper frame 41 further moves to the center side of the liquid crystal module 10, while the leaf spring 47 maintains the elastically deformed state.

Finally, the long hole 472 of the leaf spring 47 moves to a position overlapping with the projection 511. The non joint region of the leaf spring 47 is warped to the front side by an elastic restoring force stored therein. The projection 511 is fitted to the long hole 472 (see FIG. 3). The minor axis of the long hole 472 (diameter in the direction substantially orthogonal to the extending direction of the upper frame 41 or the diameter in a vertical direction of the television receiver 1) is substantially the same as the diameter of the projection 511. Meanwhile, the major axis of the long hole 472 (diameter in the extending direction of the upper frame 41 or in the lateral direction of the television receiver 1) is longer than the diameter of the projection 511. Therefore, with being fitted to the long hole 472, the projection 511 is tightly fitted in the minor axial direction of the long hole 472, while being loosely fitted in the major axial direction of the long hole 472.

When the projection 511 is fitted to the long hole 472, the upper frame 41 is temporarily fixed in the vertical direction with respect to the liquid crystal module 10. When the projection 511 is fitted to the long hole 472, the upper frame 41 is temporarily fixed in the lateral direction with respect to the liquid crystal module 10 while having a slight allowance. Therefore, the position of the upper frame 41 can be finely controlled in the lateral direction with respect to the liquid crystal module 10.

FIGS. 7, 8, 9 and 10 illustrate the process of attaching the upper frame 41 to the liquid crystal module 10. Also, a process of attaching the side frames 42 and 43 to the liquid crystal module 10 is similar to the process illustrated in FIGS. 7, 8, 9 and 10.

When the projection 511 is fitted to the long hole 472, the side frames 42 and 43 are temporarily fixed in the lateral direction with respect to the liquid crystal module 10. When the projection 511 is fitted to the long hole 472, the side frames 42 and 43 are temporarily fixed in the vertical direction with respect to the liquid crystal module 10 while having a slight allowance. Therefore, the positions of the side frames 42 and 43 can be finely controlled in the vertical direction with respect to the liquid crystal module 10.

When the plurality of projections 511 are respectively fitted to the long holes 472 of the leaf springs 47 provided on the upper frame 41 and the side frames 42 and 43, the leaf springs 47 press the bottom wall 51 of the backlight chassis 5 to the front side. On the other hand, in the respective rear inner surfaces of the upper frame 41 and the side frames 42 and 43 facing the bottom wall 51, even if the portions other than the leaf spring 47 are in contact with the thickest portion of the bottom wall 51 of the liquid crystal module 10, are not in contact with the portion other than the thickest portion.

The liquid crystal module 10 has variations in the thickness thereof, however, the leaf springs 47 press the bottom wall 51 to the front side by the elastic force according to the thickness of the liquid crystal module 10. Thereby, the upper frame 41 and the side frames 42 and 43 are temporarily fixed to the liquid crystal module 10 by the leaf springs 47, without affecting an excess force with respect to the liquid crystal module 10 having the variations in the thickness thereof.

When pressing the bottom wall 51 to the front side by the non joint regions of the leaf springs 47, the joint regions of the leaf springs 47 press the respective rear portions of the upper frame 41 and the side frames 42 and 43 to the rear side. That is, the leaf springs 47 press the bottom wall 51, and the respective rear portions of the upper frame 41 and the side frames 42 and 43, in the direction separated from each other. In this case, the respective front portions of the upper frame 41 and the side frames 42 and 43, which respectively have a cross section formed in a substantially U shape, press the front peripheral edge part of the liquid crystal module 10 to the rear side. Accordingly, the leaf springs 47 serve to allow the upper frame 41 and the side frames 42 and 43 to hold the liquid crystal module 10.

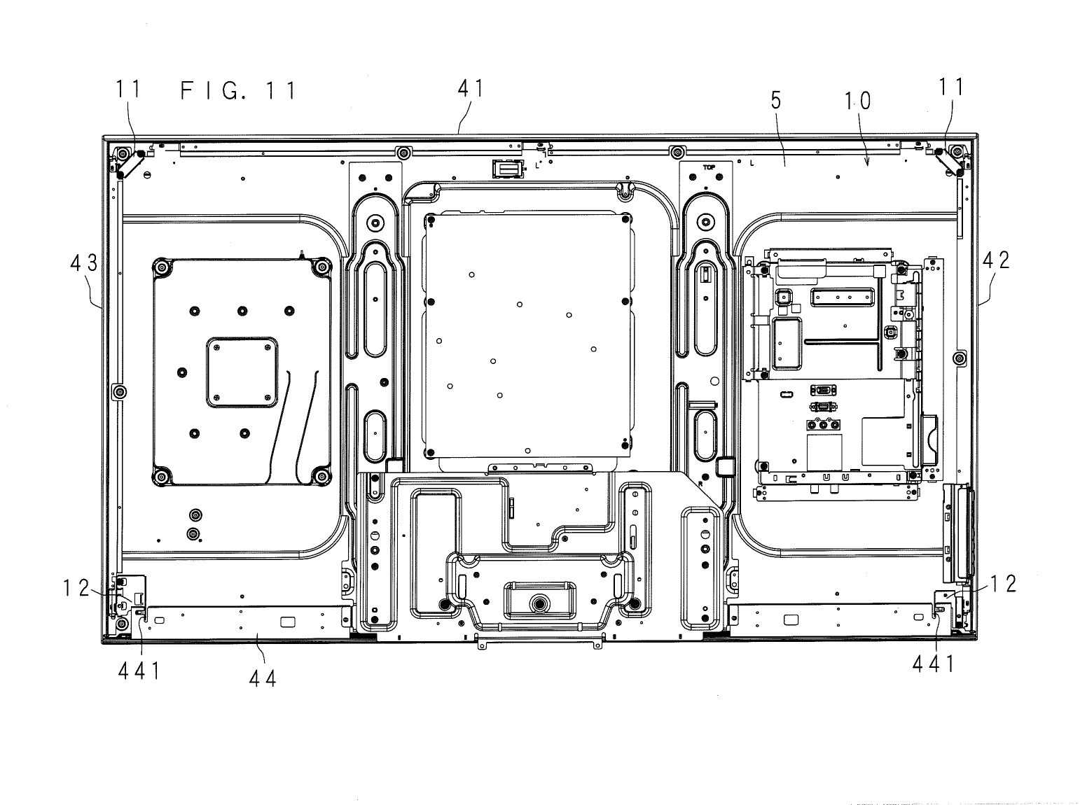

FIG. 11 is a rear view of the liquid crystal module 10 to which the upper frame 41, the side frames 42 and 43, and the lower frame 44 are attached. Tenons 411 and mortises 431, which form a tenon assembly structure and are fitted to each other, are provided at both end parts of the upper frame 41, and the upper end parts of the side frames 42 and 43, respectively (see FIG. 5). By the tenon assembly structure, the upper frame 41 whose the position in the lateral direction has been finely controlled, and the side frames 42 and 43 whose the positions in the vertical direction have been finely controlled, are coupled with each other.

The television receiver 1 includes braces (connecting members) 11. The brace 11 is an oblique member inserted between the upper frame 41 and the side frames 42 and 43. The brace 11 may be made of aluminum, iron, stainless, or the like. In the FIG. 11 illustrating the liquid crystal module 10 seen from the rear side, the left end part of the upper frame 41 and the upper end part of the frame body 43, as well as the right end part of the upper frame 41 and the upper end part of the side frame 42 are connected to each other by the screwed braces 11, respectively. The coupling power between the upper frame 41 and the side frames 42 and 43, which are coupled with each other by the tenon assembly structure, is increased by the braces 11.

The television receiver 1 includes connecting members 12 (see FIGS. 4 and 11). The connecting member 12 may be made of aluminum, iron, stainless, or the like. The projection 511 is not provided at the lower part of the bottom wall 51. Therefore, the lower frame 44 is also not provided with the leaf spring 47 for temporarily fixing or permanently fixing the lower frame 44 with respect to the liquid crystal module 10. Therefore, the lower frame 44 is fixed with respect to the liquid crystal module 10 by connecting the lower frame 44 and the side frames 42 and 43 by the connecting members 12.

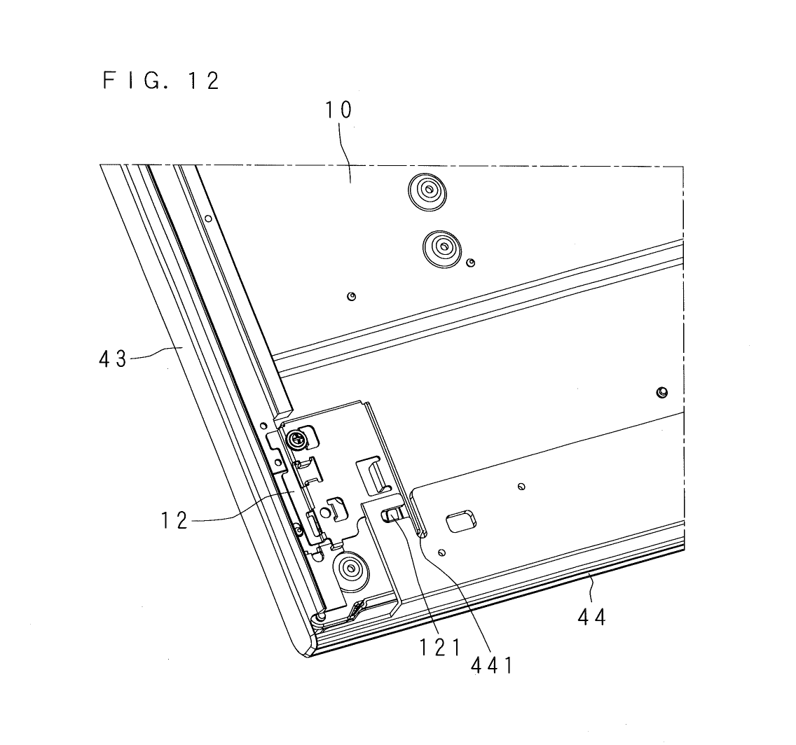

FIG. 12 is a partial perspective view of the liquid crystal module 10 to which the side frame 43 and the lower frame 44 are attached, seen from the rear side. FIG. 12 illustrates a state in which the side frame 43 and the lower frame 44 are connected and fixed by the connecting member 12 in the left lower part of the liquid crystal module 10. The connecting member 12 is fixed to the rear lower end part of the side frame 43 by the screw, for example. When seeing the liquid crystal module 10 from the rear side, the connecting member 12 is also disposed between the side frame 42 and the lower frame 44 in the right lower part of the liquid crystal module 10. Each left and right connecting member 12 has a slightly different shape from each other, but has the same function as each other.

The connecting member 12 includes a cut-and-raised piece 121. The cut-and-raised piece 121 is a projection part which is half-blanked with respect to a sheet metal and bent obliquely rearward, for example. The cut-and-raised piece 121 may be formed by simultaneously performing the half blanking and bending. In an example of FIG. 12, the cut-and-raised piece 121 is a rectangular protrusion extending upwardly and obliquely rearward from a right lower portion of the connecting member 12.

The lower frame 44 is provided with a T-shaped notch 441 on both end parts of the rear part thereof. The T-shaped notch 441 includes a substantially vertical notch and a substantially lateral notch. The substantially lateral notch is cut outward from a middle of the substantially vertical notch. The cut-and-raised piece 121 of the connecting member 12 is locked to the lateral notch portion of the T-shaped notch 441 in a form of protruding from the front side to the rear side.

When seeing the liquid crystal module 10 from the rear side, the lower frame 44 is provided with a notch 441 having a symmetrical shape with respect to the T-shaped notch 441 illustrated in FIG. 12 on the right end part thereof (see FIG. 11). When seeing the liquid crystal module 10 from the rear side, the cut-and-raised piece 121 of the connecting member 12 located at right side is also locked to the lateral notch portion of the T-shaped notch 441 in a form of protruding from the front side to the rear side.

The upper frame 41 and the side frames 42 and 43, which are respectively temporarily fixed to the upper and side parts of the liquid crystal module 10, and the lower frame 44 attached to the lower part of the liquid crystal module 10 are connected by the braces 11 and the connecting members 12. As a result, the upper frame 41, the side frames 42 and 43, and the lower frame 44 are rigidly fixed with respect to the liquid crystal module 10, as the frame body 4.

Next, a method of assembling the television receiver 1 will be described. Hereinafter, the liquid crystal module 10 is considered that it has been pre-assembled.

The liquid crystal module 10 is placed on a substantially horizontal table with the rear side facing upward. The side frames 42 and 43 are respectively placed at the side parts of the liquid crystal module 10 with the sides opened in a U shape facing inward. The side frames 42 and 43 are positioned with respect to the liquid crystal module 10, so that the long hole 472 of the leaf spring 47 faces the projection 511. The side frames 42 and 43 are pressed, and are moved to the inside (center side) of the liquid crystal module 10. Then, the projection 511 is fitted to the long hole 472 of the leaf spring 47, to temporarily fix the side frames 42 and 43 to the liquid crystal module 10.

The upper frame 41 is temporarily fixed to the liquid crystal module 10, in the same manner as the side frames 42 and 43. By finely moving the upper frame 41 and the side frames 42 and 43 in a circumferential direction of the liquid crystal module 10, the upper frame 41 and the side frames 42 and 43 are coupled with each other by the tenon assembly structure. The coupled upper frame 41 and the side frames 42 and 43 are connected to each other by the braces 11.

The lower frame 44 is placed at the lower part of the liquid crystal module 10 with the side opened in a U shape facing inward. The lower frame 44 is pressed, and is moved to the inside of the liquid crystal module 10. By finely moving the lower frame 44 in the lateral direction, the both end parts of the lower frame 44 are jointed to the lower parts of the side frames 42 and 43.

The connecting members 12 are disposed between the side frames 42 and 43 and the lower frame 44, so that the cut-and-raised pieces 121 are fitted to the T-shaped notches 441 of the lower frame 44. In this case, first, the cut-and-raised piece 121 of the connecting member 12 is put in the vertical notch of the notch 441. Then, the cut-and-raised piece 121 is put from the vertical notch into the lateral notch, to be locked to the notch 441.

The left and right connecting members 12 disposed between the side frames 42 and 43, and the lower frame 44 are fixed to the side frames 42 and 43 by the screws. Thereby, the upper frame 41, the side frames 42 and 43, and the lower frame 44 temporarily fixed to the liquid crystal module 10 are united as the frame body 4, and are fixed to the liquid crystal module 10.

The back cabinet 3 is close to the liquid crystal module 10, to which the frame body 4 is fixed, from the top, so as to come into contact with the frame body 4 and the bottom wall 51. The back cabinet 3 is aligned with respect to the frame body 4, and the aligned back cabinet 3 is fixed to the liquid crystal module 10 by the screws.

In the present embodiment, the bottom wall 51 of the backlight chassis 5 is pressed to the front side by the leaf spring 47. However, the elastic member for pressing the bottom wall 51 of the backlight chassis 5 is not limited to the leaf spring 47, and rubber, an air spring, flexible plastic, or the like may be used. For example, when using the rubber as the elastic member, plate-shaped or aggregated rubber provided with a hole to which the projection 511 is tightly fitted or loosely fitted is mounted on the rear inner surfaces of the upper frame 41, etc.

Alternately, the elastic member may be a composite member made of a plurality of materials. For example, a metal plate provided with a hole to which the projection 511 is tightly fitted or loosely fitted may be adhered to the surface of the elastic member facing the bottom wall 51. Thereby, when attaching the upper frame 41, etc. to the liquid crystal module 10, since the metal plate is easy to slip on the projection 511 compared to rubber, for example, the attaching operation of the upper frame 41, etc. can be easily performed.

In the present embodiment, the television receiver 1 has an edge light type backlight which includes the reflection sheet 6, the light guide plate 7 and the light emitting diodes. However, the television receiver 1 may also have a direct type backlight.

In the present embodiment, the lower frame 44 is not provided with the first notch 45, second notch 46 and the leaf spring 47, and the lower part of the bottom wall 51 is not provided with the projection 511. However, the lower frame 44 may be provided with the first notch 45, second notch 46 and the leaf spring 47, and the lower part of the bottom wall 51 may be provided with the projection 511, so as to temporarily fix the lower frame 44 to the liquid crystal module 10.

In the present embodiment, the outer bezel 92 has an L-shaped cross section shape, and the front surface part thereof is pinched between the front surface part of the frame body 4 and the front surface peripheral edge part of the liquid crystal panel 2. However, the front surface part of the outer bezel 92 may be further narrowed, or may be omitted. In this case, since the front surface part of the frame body 4 is in contact with the front surface peripheral edge part of the liquid crystal panel 2, thinning of the television receiver 1 can be achieved by as much as the thickness of the outer bezel 92.

According to the television receiver 1, narrowing of the frame can be achieved.

It is conceivable to use the screws as a means for fixing the frame body 4 to the liquid crystal module 10. However, when fixing the frame body 4 to the liquid crystal module 10 by the screws, it is necessary to provide bosses for screwing the screws on the liquid crystal module 10 in the in-plane direction thereof. The bosses cause greater difficulty in narrowing of the television receiver 1. In addition, when fixing the frame body 4 to the existing liquid crystal module 10 which has been assembled by using the screws on the front-back direction, it is necessary to newly form screw holes for screwing in the liquid crystal module 10, such that productivity and the quality of the television receiver 1 may be undermined.

In the television receiver 1, since the projection 511 of the backlight chassis 5 is fitted to the long hole 472 of the leaf spring 47 to be temporarily fixed, it is not necessary to dispose a member for fixing the frame body 4 to the liquid crystal module 10 on the outside of the liquid crystal module 10. The brace 11 and the connecting member 12 for increasing the coupling strength of the frame body 4 and reinforcing the fixation between the frame body 4 and the liquid crystal module 10 are members disposed on the inside of the liquid crystal module 10. Accordingly, in the television receiver 1, since only the frame body 4 is disposed on the outside of the screen 21, narrowing of the frame can be achieved.

The liquid crystal module 10 has variations in the thickness thereof. However, only the leaf spring 47 presses the bottom wall 51 of the liquid crystal module 10 to the front side, and most areas of the inner surface of the frame body 4 is not in contact with the bottom wall 51. Therefore, a strong force in the front-back direction is not applied to the optical sheet 8, etc. included in the liquid crystal module 10, such that the image quality of the television receiver 1 is not deteriorated.

It is possible to easily control the magnitude of force for pinching the liquid crystal module 10 in the front-back direction by a design change of the leaf spring 47. For example, it is possible to optimize the strength and the manufacturing cost of the television receiver 1, while retaining the image quality, by properly increasing or decreasing the thickness, size and the number of the leaf spring 47. Further, the material of the leaf spring 47 may also be appropriately changed in the process of optimization.

The second projection piece 474 and the second notch 46 have the function of a stopper for inhibiting excessive variation and movement of the leaf spring 47. In addition, since the excessive variation and movement of the leaf spring 47 are inhibited by the second projection piece 474 and the second notch 46, separation of the leaf spring 47 from the upper frame 41 or the side frames 42 and 43 is prevented.

One end part (joint region) of the leaf spring 47 is fixed to the edge part of the first notch 45 by caulking. On the other hand, the other end of the leaf spring 47 is a free end. Therefore, there is a concern of deforming the leaf spring 47 by a force such as torsion, vibration, rotation, or the like applied from the outside, during assembling or transporting of the television receiver 1. In some cases, the leaf spring 47 may be separated from the upper frame 41 or the side frames 42 and 43. However, when the leaf spring 47 is excessively deformed, the tip end of the second projection piece 474 is in contact with the inner wall of the second notch 46, whereby deformation of the leaf spring 47 is prevented, and separation of the leaf spring 47 from the upper frame 41 or the side frames 42 and 43 is also prevented.

### Embodiment 2

Embodiment 2 relates to a configuration in which the leaf spring 47 is fixed to the upper frame 41 and the side frames 42 and 43 by the screws.

In Embodiment 1, the joint region of the leaf spring 47 and the respective inner surfaces of the upper frame 41 and the side frames 42 and 43 are jointed by caulking using a rivet, etc., for example. In Embodiment 2, the joint region of the leaf spring 47 and the respective outer surfaces of the upper frame 41 and the side frames 42 and 43 are jointed by screws.

The same parts of the configuration according to Embodiment 2 as those in Embodiment 1 will be denoted by the same reference numerals, and will not be described in detail.

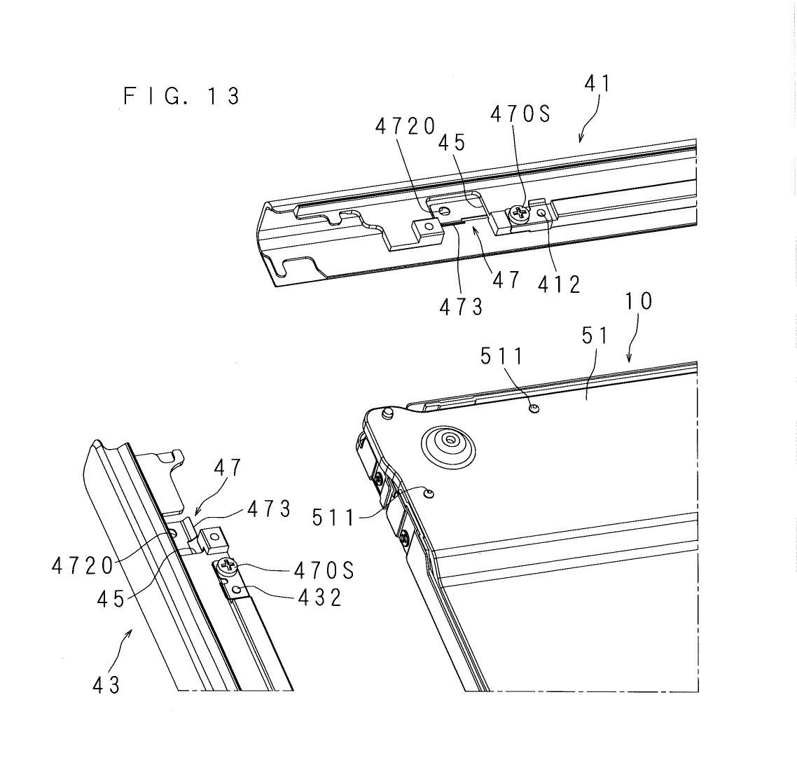

FIG. 13 is a partial enlarged view of a left upper portion of the liquid crystal module 10, and a part of each of the upper frame 41 and the side frame 43, seen from the rear side.

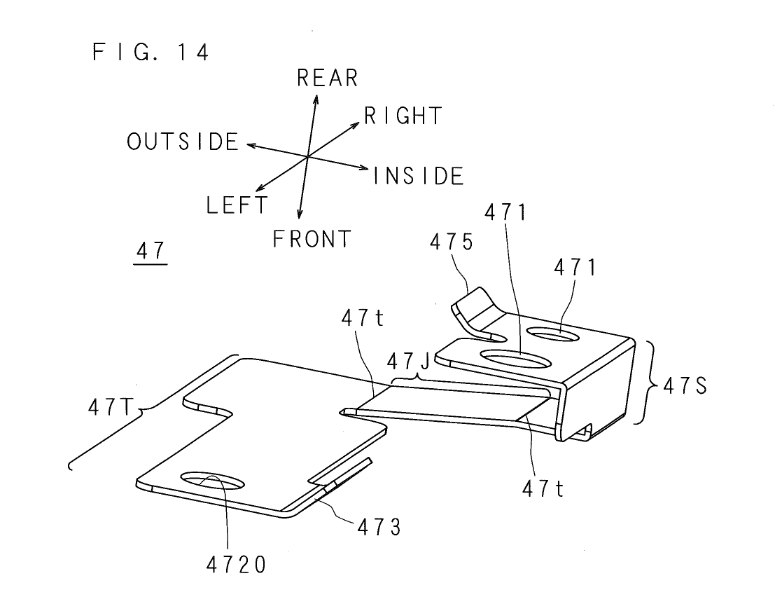

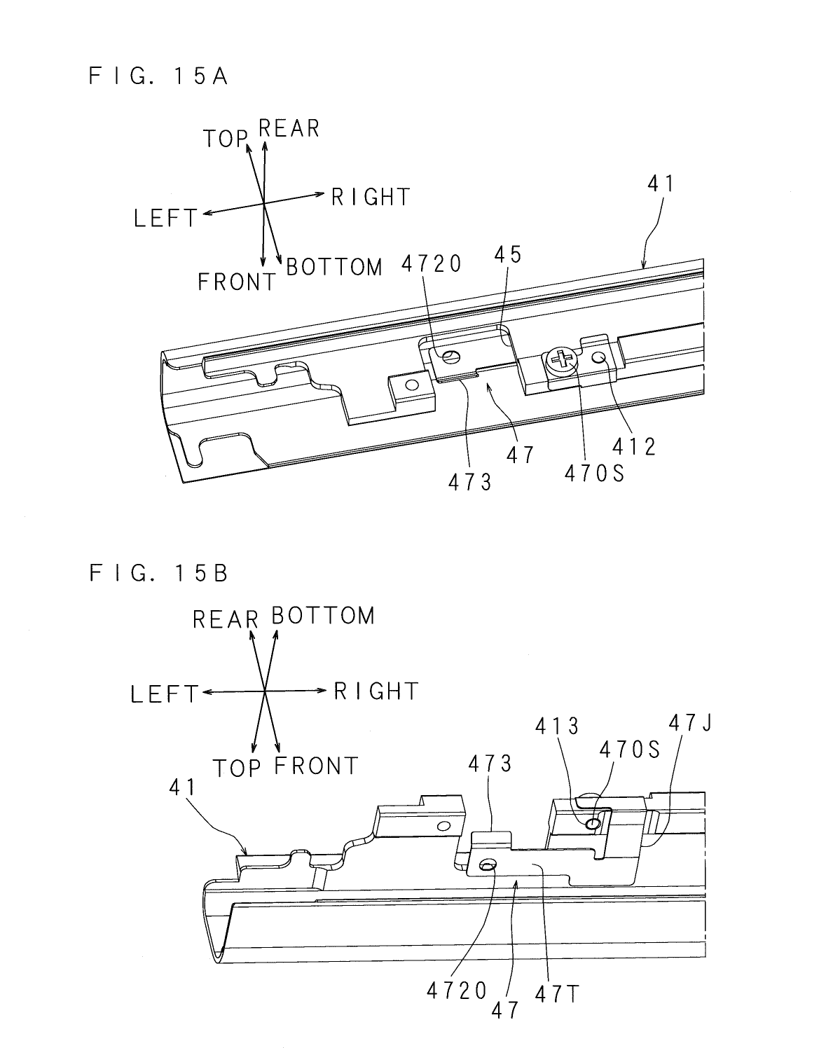

The leaf springs 47 are fixed to the respective rear portions of the upper frame 41 and the side frames 42 and 43 by screws 470S. The screw 470S is inserted into the circular hole 471 of each leaf spring 47 as a screw insertion hole (see FIG. 14), and then is screwed to screw hole 413 provided in the respective rear portions of the upper frame 41 and the side frames 42 and 43 (see FIG. 15B).

In addition, each of the upper frame 41 and the side frames 42 and 43 is provided with projections 412 and 432 to be fitted to the circular hole 471 of the leaf spring 47, on the outer surface of the respective rear portion thereof. The leaf springs 47 are rigidly fixed to the upper frame 41 and the side frames 42 and 43 by fitting the projections 412 and 432 to the circular holes 471, in addition to the fixation by the screws 470S.

By fitting the projection 511 of the backlight chassis 5 to the hole 4720 of the leaf spring 47, the upper frame 41 and the side frames 42 and 43 are temporarily fixed to the liquid crystal module 10. In this regard, it is similar to that the projection 511 is fitted to the long hole 472 in Embodiment 1.

In addition, in Embodiment 2, the upper frame 41 and the side frames 42 and 43 are not provided with the second notch 46, and the leaf spring 47 is not provided with the second projection piece 474. However, the upper frame 41 and the side frames 42 and 43 may be provided with the second notch 46, and the leaf spring 47 may be provided with the second projection piece 474.

FIG. 14 is a perspective view of the leaf spring 47. FIG. 14 illustrates the rear side of the leaf spring 47, seen from the inside of the television receiver 1 to the outside. An orientation is illustrated in a top of FIG. 14 for reference.

The leaf spring 47 includes a contact part 47T, a separation part 47S and a connection part 47J. The contact part 47T is a portion to be in contact with the bottom wall 51 of the backlight chassis 5, when the upper frame 41 and the side frames 42 and 43 are attached to the liquid crystal module 10. The contact part 47T is provided with the circular hole 4720 to which the projection 511 of the backlight chassis 5 is fitted. The shape of the hole 4720 may be a long hole, elliptical, oval, rectangular shape or the like.

The separation part 47S is a portion to be separated from the bottom wall 51 of the backlight chassis 5, when the upper frame 41 and the side frames 42 and 43 are attached to the liquid crystal module 10. The separation part 47S is formed in a U shape opened outward, when cut on a cutting surface substantially orthogonal to the longitudinal direction (the extending direction) of the upper frame 41 or the side frames 42 and 43. The respective rear portions of the upper frame 41 and the side frames 42 and 43 are configured so as to be sandwiched inside of the U shape of the separation part 47S.

The separation part 47S is provided with two circular holes 471 in the extending direction of the upper frame 41 or the side frames 42 and 43, at portions thereof being in contact with the respective rear outer surfaces of the upper frame 41 and the side frames 42 and 43. In FIG. 14, the front side or the left side circular hole 471 is a screw insertion hole into which the screw 470S is inserted for fixing the leaf spring 47 to the upper frame 41 and the side frames 42 and 43. In order to easily perform the operation of fixing the leaf spring 47 to the upper frame 41 and the side frames 42 and 43 by the screws 470S, the circular holes 471 are provided in the rear surface of the separation part 47S to be in contact with the outer surfaces of the upper frame 41 and the side frames 42 and 43.

In FIG. 14, the rear side or the right side circular hole 471 is a through hole into which the projection 412 and 432 are inserted for respectively fixing the leaf spring 47 to the upper frame 41 and the side frames 42 and 43. The reason for providing the projections 412 and 432 on the respective outer surfaces of the upper frame 41 and the side frames 42 and 43, and providing the circular holes 471 to which the projections 412 and 432 are fitted in the rear surface of the separation part 47S is to easily perform the fixing operation.

When attaching the leaf spring 47 to the upper frame 41 and the side frames 42 and 43, the side opened in a U shape of the separation part 47S is close to the respective rear portions of the upper frame 41 and the side frames 42 and 43 from the inside to the outside. Then, the respective rear portions of the upper frame 41 and the side frames 42 and 43 are sandwiched by the separation part 47S. In this case, a third projection piece 475 for guiding the projections 412 and 432 to the circular holes 471 is extended from the rear surface of the separation part 47S, so as to smoothly perform the fitting of the projections 412 and 432 to the circular holes 471. The third projection piece 475 extends obliquely rearward from the outer edge part of the rear surface of the separation part 47S, at the outside position from the circular holes 471 to which the projections 412 and 432 are fitted. When pressing the separation part 47S to the rear portions of the upper frame 41 and the side frames 42 and 43 from the inside to the outside, the projections 412 and 432 ride on the third projection piece 475, such that the attaching operation of the separation part 47S can be smoothly performed.

The connection part 47J is located between the contact part 47T and the separation part 47S, and is a portion for connecting the contact part 47T and the separation part 47S. The connection part 47J is formed in a rectangular shape, and bending lines 47t substantially parallel to the extending direction of the upper frame 41 or the side frames 42 and 43 are formed at end parts in respective contact with the contact part 47T and the separation part 47S. The connection part 47J is inclined in the front-back direction by the bending of the bending line 47t, and the contact part 47T is located at the front side with respect to the separation part 47S.

The separation part 47S corresponds to the joint region which is jointed to the upper frame 41 and the side frames 42 and 43. On the other hand, the contact part 47T and the connection part 47J correspond to the non-joint region which is not jointed to the upper frame 41 and the side frames 42 and 43.

FIGS. 15A and 15B are perspective views of the upper frame 41. FIG. 15A illustrates the outer surface of the rear portion of the upper frame 41. FIG. 15B illustrates the inner surface of the rear portion of the upper frame 41. Orientations are illustrated in a top of respective FIGS. 15A and 15B for reference.

When seeing the outer surface of the rear portion of the upper frame 41 from the rear side (see FIG. 15A), the contact part 47T of the leaf spring 47 partially closes the first notch 45. In addition, When seeing the outer surface of the rear portion of the upper frame 41 from the rear side, the separation part 47S of the leaf spring 47 is fixed by the screws 470S and the projection 412. The contact part 47T is located at the slight front side from the opening surface of the first notch 45, by the bending of the bending lines 47t at the both ends of the connection part 47J.

When seeing the inner surface of the rear portion of the upper frame 41 from the front side (see FIG. 15B), the contact part 47T and the connection part 47J of the leaf spring 47 are exposed to the inner surface of the rear portion of the upper frame 41, and a portion of the contact part 47T partially closes the first notch 45. The contact part 47T is located at the slight front side from the opening surface of the first notch 45, by the bending of the bending lines 47t at the both ends of the connection part 47J. When the upper frame 41 is attached to the liquid crystal module 10, the contact part 47T overhanging the front side presses the bottom wall 51 of the backlight chassis 5 to the front side, such that the upper frame 41 is temporarily fixed to the liquid crystal module 10, without excessively pressing the liquid crystal module 10.

The location of the leaf spring 47 in the upper frame 41 is the same as the above description. The locations of the leaf springs 47 in the side frames 42 and 43 are similar to the location of the leaf spring 47 in the upper frame 41, and therefore will not be described.

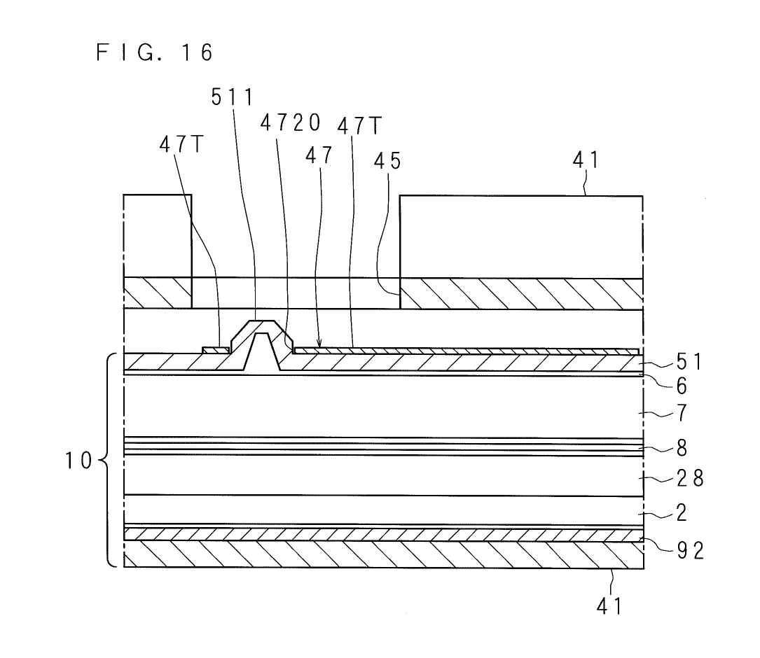

FIG. 16 is a cross-sectional view of the upper frame 41 and the liquid crystal module 10 attached to each other, cut on a horizontal plane passing through the projection 511. FIG. 16 illustrates a cross section taken on line XVI-XVI in FIG. 3 seen from the top. The top of FIG. 16 corresponds to the rear side of the television receiver 1, and the bottom of FIG. 16 corresponds to the front side of the television receiver 1.

The projection 511 provided on the bottom wall 51 of the backlight chassis 5 is fitted to the hole part 4720 provided in the contact part 47T of the leaf spring 47. Thereby, the upper frame 41 is fixed to the liquid crystal module 10. In addition, even if the liquid crystal module 10 has variations in the thickness thereof, the contact part 47T of the leaf spring 47 is elastically deformed to the front side, while pressing the liquid crystal module 10 to the front side. Thereby, it is possible to prevent the projection 511 from being separated from the hole 4720.

According to the television receiver 1, the respective members laminated in the front-back direction can be fixed while permitting variations in the thickness of the respective members.

The leaf spring 47 presses the bottom wall 51 of the liquid crystal module 10 to the front side, while permitting variations in the thickness of the respective members. When attaching the upper frame 41 and the side frames 42 and 43 to the liquid crystal module 10, the contact part 47T of the leaf spring 47 according to Embodiment 2 presses the bottom wall 51 by the connection part 47J which is elastically deformed. Thereby, the respective members are fixed each other.

The leaf springs 47 are fixed to the respective rear portions of the upper frame 41 and the side frames 42 and 43 by the screws 470S. Since the fixing power of the screws 470S is stronger than the fixing power by caulking, the possibility of falling of the leaf spring 47 from the upper frame 41 and the side frames 42 and 43, is further reduced.

As this description may be embodied in several forms without departing from the spirit of essential characteristics thereof, the present embodiments are therefore illustrative and not restrictive, since the scope is defined by the appended claims rather than by the description preceding them, and all changes that fall within metes and bounds of the claims, or equivalence of such metes and bounds thereof are therefore intended to be embraced by the claims.

In addition, technical characteristics (components) described in each embodiment may be combined with each other, and by combining these components, new technical characteristics may be formed.

1.-6. (canceled)

7. A liquid crystal display apparatus comprising:
a liquid crystal module that has: a liquid crystal panel, an optical sheet, a backlight, and a housing which has an opening on its front side and houses at least the optical sheet and the backlight, which are sequentially laminated from a front side to a rear side; and a frame-shaped member which covers peripheral surface sides of the liquid crystal panel and the housing;
a frame body that covers a peripheral edge part and a peripheral surface of the liquid crystal module, and is partially in contact with the housing and the frame-shaped member to pinch the liquid crystal module; and
an elastic member that is installed at a portion where a rear surface of the housing and the frame body face each other, and presses the housing and the frame body so as to be separated from each other in a thickness direction of the housing.

8. The liquid crystal display apparatus according to claim 7, wherein the elastic member is a leaf spring.

9. The liquid crystal display apparatus according to claim 8, wherein
the leaf spring has a hole, and
the housing is provided with a projection to be fitted in the hole on the rear surface thereof facing the hole.

10. The liquid crystal display apparatus according to claim 9, wherein
the frame body has a notch opened inward in a portion facing the rear surface of the housing, and
the leaf spring is provided so as to close at least a part of the notch.

11. The liquid crystal display apparatus according to claim 9, wherein
the leaf spring is provided with a projection piece in an edge part thereof on an inside from the hole, and
the projection piece extends obliquely rearward with respect to the rear surface of the housing.

12. The liquid crystal display apparatus according to claim 7, wherein
the liquid crystal module and the frame body have a rectangular shape in a front view, respectively, and
the elastic member is provided on at least one side of the frame body facing the rear surface of the housing.
